(19) United States
(12) Patent Application Publication
(10) Pub. No.: US 2003/0036965 A1
(43) Pub. Date: Feb. 20, 2003

(54) Method for the on-line solicitation of goods and/or services by pre-identified purchasers

(76) Inventor: Mitchell Blashinsky, Manalapan, NJ (US)

Correspondence Address: Charles I. Brodsky, 2 Bucks Lane, Marlboro, NJ, 07746, US

(21) Appl. No.: 09/931,524

(22) Filed: Aug. 17, 2001

(51) Int. Cl. G06F 17/60

(52) U.S. Cl. 705/26

(57) ABSTRACT

A method which interactively matches via Internet connection pre-identified common interest group purchasers of defined categories of goods and/or services from vendors thereof through the assigning of identified codes to the common interest group purchasers and permitting vendor response to information requests by at least one of regular mail, telephone, facsimile and electronic mail.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to a method for the ON-LINE solicitation of goods and/or services by pre-identified purchasers and, more particularly, by the interactive ordering of goods and/or services by Condominium Associations.

2. Description of the Related Art

As is known, the theory underlying most advertising today is the keeping of the goods or service provider's name before the purchasing public as much as possible—the theory being that at such time as a purchase of such goods and/or services is being considered, the name and identity of the advertiser as a provider will be immediately recalled. In practice, however, the implementation of such belief is unduly and inefficiently expensive. First, the advertising cost is spent on getting the message through to purchasers who may not at that instant of time be in need of the goods and/or services being promoted. Second, the advertising dollars are being spent on spreading the message to purchasers who may never be in the market for those goods and/or services being offered to begin with.

As will become clear from the following description, on the other hand, the present invention describes a method of pinpointing the advertisement only to those purchasers who would be in the market for the goods and/or services being offered—and substantially only at the time that an interest is expressed by the purchaser for those goods and/or services. As will also become clear, the method of this invention is particularly useful for any common interest group (as contrasted with the general public), and is especially attractive for such common interest group purchasers of goods and/or services as Condominium Associations.

### SUMMARY OF THE INVENTION

Condominium Association purchasers of goods and/or services, it is known, are repeatedly in the market for structural, mechanical, electrical, plumbing, air-conditioning, and similar such repair services; also, they are constantly in need of landscaping and lawn maintenance, snow removal and trash collection services—and a myriad of other needs, such as stationery supplies, office furniture, recreation room equipment, fitness center machines, arts & crafts materials, etc. Typically, when a purchase of such goods and/or services is contemplated, the process entails an investigation to find what providers exist, telephone or written requests of those providers for information, a dissemination of such transmitted request amongst the various personnel of the contacted providers to convey what the information request is, and then a forwarding of what is believed to be the requested information from the provider to the initiating requester. Hopefully, according to the interests of the provider, the requester will remember it as being one of the advertisers of such goods and/or services from either the print or broadcast media, or by direct mail.

In accordance with the teachings of the present invention, this process of soliciting information of the provider is simplified, and the cost of the advertising by the provider is focused and significantly reduced. While the invention may be described in the context of a Condominium Association soliciting the information, it will be appreciated by those skilled in the art that the method to be described is applicable to just about any common interest group purchaser of a defined category of goods and/or services which regularly needs to be filled. In such respect, the invention will be seen to be equally applicable to Trial Lawyers, for example, who oftentimes are in need of experts in different fields of engineering to provide litigation support, as well as photographic studios, different medical specialists, investigators, and so forth.

Thus, as will be seen, the method of the invention establishes a first database of pre-identified common interest purchase customers of defined categories of these goods and/or services of concern. The method also establishes a second database of vendors of such defined categories of goods and/or services. Interactive matching then follows according to the invention, and via Internet connection, of a request for particular goods and/or service information from a potential interest purchaser to which the invention is particularly useful, to a vendor thereof. The method then permits sending of such information from the selected vendor to the requesting purchaser by at least one of regular mail, telephone, facsimile and electronic mail.

### DETAILED DESCRIPTION OF THE INVENTION

In carrying out the invention, the first step of the method pre-assigns an identifying code which is unique to each potential purchaser included within the first database. Such unique code may identify a given Condominium Association by name, address, telephone number, e-mail address, and contact person, as an example. The method also includes the step of providing to a selected vendor such unique identifying code to permit a response from the selected vendor to the requesting purchaser. For the Trial Lawyer, this may comprise the forwarding of the similar identification information to the engineering expert, the medical specialist, etc. instead of the snow removal contractor or plumber with the Condominium Association, obviously substituting the Lawyer identification for that of the Condominium Association. As will be understood, the vendor in such arrangement is included in the database in accordance with the specialized goods and/or services it provides as being available for contact and solicitation. As part of the information request made by the purchaser, such solicitation also includes the providing of its pre-assigned identifying code to enable the provider to respond. Such identifying code is pre-assigned by the system operator of the method, who also establishes the various databases and solicits vendor listing therein under the categories of goods and/or services there being made available for Internet view. In return for including such vendor registry in the database and for making its advertising information available via the Internet, the invention includes the additional step of allowing the system operator to pre-bill each vendor a cost for inclusion within the database. In addition, a further charge may be allowed, in accordance with the invention, for each contact a requester of information makes of that provider.

According to the invention, the method further includes the system operator's monitoring the request to allow for the inclusion of, and the e-mail solicitation by, the requesting common interest purchaser free of charge. Upon receipt of the solicitation request, the vendor can respond in any manner it chooses—by electronic mail, by regular mail, by facsimile, or directly by telephone—or even in person, if requested by the interested purchaser. Such establishment of the database of available vendors of such goods and/or services may be maintained for the same or different geographical locale or boundary of the requesting purchaser—although with respect to the Condominium Association purchaser, a preference might be for matching with vendors located in the same geographical area, although for the Trial Lawyer, such limitation might be too restrictive.

In carrying out the method of the invention, the system operator creates the database of vendors, by type; the system operator then sends to each Condominium Association, Trial Lawyer Association litigator, a pre-assigned identifying code which identifies that entity. When the Condominium Association, for example, clicks on the Website of the system operator, it identifies its code number, and proceeds through the database looking for the type of goods and/or services it then needs. By clicking on a vendor number, next, that vendor automatically receives the inquiry from the requester acknowledging that it is in the market for that type of goods or services offered, and reaches out by providing the requested details to enable a bid to be made by the purchaser, by regular mail, electronic mail, facsimile, telephone, etc. As will be appreciated, the system operator thereby provides a degree of convenience in the process by eliminating the various interview steps, and primarily through the assignment of the pre-identified code for each potential common interest purchaser. Because the general public is just too large in number, assignment of such pre-identifying codes to each and every person is considered to be too insurmountable a task to permit the method of the invention to be used by just anyone, and will be understood to be limited to the purchaser or user of the available goods, and/or services contemplated in the carrying out of the invention. In other words, a need to focus on the specific group of purchasers is involved; namely, those who require specific services in carrying on their activities. In essence, the teachings of the invention are particularly useful in all fields of endeavor where the system operator can identify the purchasers very closely and the vendors which provide the goods and/or services normally needed by those purchasers on a recurrent basis. In such manners, the interactive match via Internet connection can be secured to enable the solicitation of requested information to be conveniently and inexpensively had.

While there has been described what are considered to be preferred embodiments of the present invention, it will be readily appreciated that modifications can be made by those skilled in the art without departing from the scope of the teachings herein. For at least such reason, therefore, resort should be had to the claims appended hereto for a true understanding of the extent of the invention.

I claim:

1. A method for the ON-LINE solicitation of goods and/or services by pre-identified purchasers, comprising:
first, establishing a first database of pre-identified common interest purchasers of defined categories of goods and/or services;
second, establishing a second database of vendors of said defined categories of goods and/or services;
third, interactively matching via Internet connection a request for particular goods and/or service information from a common interest purchaser to a vendor thereof; and
fourth, sending such information from a selected vendor to the requesting purchaser by at least one of regular mail, telephone, facsimile and electronic mail.

2. The method of claim 1, wherein said first step pre-assigns an identifying code unique to each common interest purchaser included within said first database.

3. The method of claim 2, also including the step of providing automatically to said selected vendor identification information to permit response from said selected vendor to said requesting common interest purchaser.

4. The method of claim 3 wherein said third step includes the providing of said identifying code by said purchaser as part of the information request.

5. The method of claim 3, additionally including the step of a pre-billing of each vendor a cost for inclusion within said second database.

6. The method of claim 5, further including the step of a solicitation of common interest purchasers to enrol within said first database.

7. The method of claim 5, further including the step of a solicitation of common interest purchasers to enrol within said first database free of charge.

8. The method of claim 6 wherein said first step establishes a database of Condominium Association purchasers and wherein said second step establishes a database of vendors providing goods and/or services thereto.

9. The method of claim 8 wherein said first and second steps establish databases of Condominium Association purchasers and vendor providers located within the same geographical boundary.

10. The method of claim 8 wherein said first and second steps establish databases of Condominium Association purchasers and vendor providers located within the same or different geographical boundary.
